(19) United States
(12) Patent Application Publication
(10) Pub. No.: US 2008/0129477 A1
(43) Pub. Date: Jun. 5, 2008

(54) Transmission Device, Keyless Entry System, and Tire Pneumatic Pressure Monitoring System

(75) Inventors: Naoki Takahashi, Kyoto (JP); Youichi Kajiwara, Kyoto (JP)

Correspondence Address: FISH & RICHARDSON P.C., P.O. BOX 1022, MINNEAPOLIS, MN, 55440-1022, US

(73) Assignee: ROHM CO., LTD., Kyoto (JP)

(21) Appl. No.: 11/721,518

(22) PCT Filed: Nov. 18, 2005
(86) PCT No.: PCT/JP05/21204

§ 371 Date: Jun. 12, 2007

(30) Foreign Application Priority Data
Dec. 28, 2004 (JP) 2004-380821
Dec. 28, 2004 (JP) 2004-380831

(51) Int. Cl. H04B 1/04; E05B 49/00; B60R 25/00

(52) U.S. Cl. 340/442; 340/5.21

(57) ABSTRACT

According to the invention, a transmission device has a transmission antenna portion, an output portion that has a first switch and a second switch connected in series between two different potentials and that derives from the node between the first and second switches an output current fed to the transmission antenna portion, an output driving portion that controls turning-on and -off of the first and second switches, and duty ratio setting means for variably setting the duty ratio at which the output driving portion drives the first and second switches. The invention makes it possible to adjust the radiowave coverage area of the transmission antenna portion easily without complicated work.

### TECHNICAL FIELD

The present invention relates to transmission devices that transmit a signal by use of an antenna. More particularly, the invention relates to transmission devices for use in keyless entry systems (smart-key systems) that allow locking/unlocking of a locking mechanism on a non-contact basis and tire pneumatic pressure monitoring systems (hereinafter “TPMSs”) that monitor the pneumatic pressure and temperature of tires to warn about an abnormality such as an abnormally low pneumatic pressure or abnormally high temperature.

### BACKGROUND ART

In recent years, keyless entry systems that allow locking/unlocking of a locking mechanism on a non-contact basis have been becoming increasingly widespread. Such keyless entry systems are classified into: a manual type that performs one-way communication from a remote-control key carried around by a user to a locking mechanism; and a passive type that performs two-way communication between the two ends.

One example of the latter type is passive keyless entry systems for vehicles that allow non-contact, automatic locking and unlocking of a door lock mechanism. In such systems, locking and unlocking of a door lock mechanism are controlled according to whether or not two-directional communication is established between a transmitter/receiver unit mounted on a vehicle and a remote-control key carried around by a user. More specifically, in conventional keyless entry systems, when the user goes so far away from the vehicle that no two-directional communication is established between the transmitter/receiver unit and the remote-control key, the door lock mechanism is automatically locked; on the other hand, when the user comes so close to the vehicle that two-directional communication is established between the transmitter/receiver unit and the remote-control key, the door lock mechanism is automatically unlocked.

In non-contact transmission devices like the passive keyless entry systems described above, the transmission antenna portion of the transmitter/receiver unit is generally configured as an RLC series resonance circuit (e.g., see Patent Document 1 listed below); a rectangular pulse signal having a predetermined duty ratio (typically 50%) is applied to the RLC series resonance circuit so that a request signal (a start signal) targeted at the remote-control key is radiated in the form of a radiowave into the air.

In the conventional transmitter/receiver unit, in view of the fact that the range within which the radiowave reaches depends on the output current through the transmission antenna portion, the radiowave coverage area of the transmission antenna portion is adjusted by appropriately setting the resistance of the resistor externally fitted as part of the RLC series resonance circuit.

As a conventional technology related to the present invention other than those mentioned above, there have been disclosed and proposed high-frequency signal switching devices configured as follows: individual transmission lines formed for a plurality of channels branch off a common transmission line in line-symmetry about it, and transistor switches are provided one on each of those individual transmission lines; here, the transistor switches for the outer channels and the transistor switches for the inner channels are given different gate widths so as to have different on-state resistances and hence different on-state transmission characteristics such that the difference in transmission loss between the outer and inner channels is compensated for (see, e.g., Patent Document 2 listed below).

Patent Document 1: JP-A-H05-291991

Patent Document 2: JP-A-2000-332502

### DISCLOSURE OF THE INVENTION

### Problems to be Solved by the Invention

Certainly, with the conventional transmitter/receiver unit, by appropriately setting the resistance of the resistor externally fitted to the RLC series resonance circuit, it is possible to adjust the radiowave coverage area of the transmission antenna portion. Inconveniently, however, replacing one externally fitted resistor with another involves extremely complicated and troublesome work, and results in lower productivity and higher cost.

Incidentally, the conventional technology of Patent Document 2 simply aims at appropriately adjusting the switching characteristics (on-state resistances) of the transistors for the different channels, and thus does not help overcome the inconvenience mentioned above.

Another inconvenience with the conventional receiver/receiver unit is that, when it is so configured that the radiowave coverage area of the transmission antenna portion is adjusted by use of a control signal fed from outside the unit, for example, a car-mounted LSI, in particular one arranged on the part of a door as in a car-mounted unit of a keyless entry system, requires a harness containing a large number of leads running from the vehicle body. Thus, there has been a demand to minimize the number of signal leads needed for communication and the like.

An object of the present invention is to provide a transmission device that allows easy adjustment of the radiowave coverage area of a transmission antenna portion without the need for complicated work, and to provide a keyless entry system and a tire pneumatic pressure monitoring system employing such a transmission device.

### Means for Solving the Problem

To achieve the above object, according to one aspect of the present invention, a transmission device is provided with: a transmission antenna portion; an output portion having a first switch and a second switch connected in series between two different potentials, an output current fed to the transmission antenna portion being derived from the node between the first and second switches; an output driving portion controlling turning-on and -off of the first and second switches; and duty ratio setting means for variably setting the duty ratio at which the output driving portion drives the first and second switches (a first configuration). With this configuration, the level of the output current flowing through the transmission antenna portion can be adjusted as desired. Thus, the radiowave coverage area of the transmission antenna portion can be adjusted easily without adjusting the components of the transmission antenna portion.

In the transmission device having the first configuration described above, the duty ratio setting means may be provided with: a supply voltage input portion generating a monitoring voltage signal varying with the supply voltage supplied to the device; a triangular wave generator generating a triangular-wave signal having a constant waveform; and a comparison portion comparing the monitoring voltage signal with the triangular-wave signal. In this case, based on a comparison result signal obtained from the comparator portion, the output driving portion generates control signals by which the turning-on and -off of the first and second switches are controlled (a second configuration). With this configuration, the radiowave coverage area of the transmission antenna portion can be adjusted simply by appropriately setting the level of the supply voltage. This eliminates the need to use an extra control signal to adjust the radiowave coverage area, and helps avoid unnecessarily increasing the device scale.

According to another aspect of the present invention, a keyless entry system is provided with: a remote-control key; a transmitter/receiver unit performing two-way communication with the remote-control key; a power supply unit supplying electric power to the transmitter/receiver unit; and a lock mechanism locked and unlocked according to whether or not two-way communication is established between the transmitter/receiver unit and the remote-control key. Here, the transmitter/receiver unit is provided with the transmission device having the first configuration described above as signal transmitting means (a third configuration).

According to another aspect of the present invention, a tire pneumatic pressure monitoring system is provided with: a sensor for monitoring the pneumatic pressure or temperature of a tire; a transmitter/receiver unit performing two-way communication with the sensor; and a power supply unit supplying electric power to the transmitter/receiver unit. Here, the transmitter/receiver unit comprises the transmission device having the first configuration described above as signal transmitting means (a fourth configuration).

With these configurations, even in a case where the radiowave coverage area of the transmission antenna portion needs to be varied according to the arrangement location of the transmitter/receiver unit (or the arrangement location of the transmission antenna portion), the radiowave coverage area of the transmission antenna portion can be adjusted without adjusting the components of the transmission antenna portion, and hence the accuracy of the communication with the remote-control key or sensor can be enhanced.

According to another aspect of the present invention, a transmission device is provided with: a transmission antenna portion; an output portion having a first switch and a second switch connected in series between two different potentials, an output current fed to the transmission antenna portion being derived from the node between the first and second switches; and an output driving portion controlling turning-on and -off of the first and second switches according to a first control signal. Here, the first and second switches are each a switch element group composed of a plurality of switch elements connected in parallel with one another, and, according to a second control signal, the output driving portion selects, from the plurality of switch elements, the switch elements whose turning-on and -off is controlled according to the first control signal (a fifth configuration).

More specifically, in the transmission device having the fifth configuration described above, the output driving portion may adjust the output current by selecting among the switching elements (a sixth configuration); the output current may be adjusted by exploiting the on-state resistances of the switching elements (a seventh configuration).

With these configurations, according to the second control signal, the on-state resistances of the first and second switches, and hence the level of the output current flowing through the transmission antenna portion, can be adjusted as desired. Thus, the radiowave coverage area of the transmission antenna portion can be adjusted easily without adjusting the components of the transmission antenna portion.

The transmission device having the fifth configuration described above may be further provided with means for generating the second control signal according to the supply voltage supplied to the device (an eighth configuration). With this configuration, the radiowave coverage area of the transmission antenna portion can be adjusted simply by appropriately setting the level of the supply voltage. This eliminates the need to use an extra control signal to adjust the radiowave coverage area, and helps avoid unnecessarily increasing the device scale.

According to another aspect of the present invention, a keyless entry system is provided with: a remote-control key; a transmitter/receiver unit performing two-way communication with the remote-control key; a power supply unit supplying electric power to the transmitter/receiver unit; and a lock mechanism locked and unlocked according to whether or not two-way communication is established between the transmitter/receiver unit and the remote-control key. Here, the transmitter/receiver unit is provided with the transmission device having the fifth configuration described above as signal transmitting means (a ninth configuration).

According to another aspect of the present invention, a tire pneumatic pressure monitoring system is provided with: a sensor for monitoring the pneumatic pressure or temperature of a tire; a transmitter/receiver unit performing two-way communication with the sensor; and a power supply unit supplying electric power to the transmitter/receiver unit. Here, the transmitter/receiver unit comprises the transmission device having the fifth configuration described above as signal transmitting means (a tenth configuration).

With these configurations, even in a case where the radiowave coverage area of the transmission antenna portion needs to be varied according to the arrangement location of the transmitter/receiver unit (or the arrangement location of the transmission antenna portion), the radiowave coverage area of the transmission antenna portion can be adjusted without adjusting the components of the transmission antenna portion, and hence the accuracy of the communication with the remote-control key or sensor can be enhanced.

### ADVANTAGES OF THE INVENTION

As described above, with transmission devices according to the present invention, and with keyless entry systems and tire pneumatic pressure monitoring systems employing them, it is possible to adjust the radiowave coverage area of the transmission antenna portion easily without the need for complicated work.

### BRIEF DESCRIPTION OF DRAWINGS

FIG. 1 A block diagram showing the keyless entry system according to a first embodiment of the invention.

FIG. 2 Flow charts of door lock control operations.

FIG. 3 A diagram illustrating the operation for adjusting the radiowave coverage area in the first embodiment.

FIG. 4 A diagram illustrating the radiowave coverage area in relation to the location where the transmitter/receiver unit is arranged.

FIG. 5 A block diagram showing the keyless entry system according to a second embodiment of the invention.

FIG. 6 A diagram illustrating the operation for adjusting the radiowave coverage area in the second embodiment.

FIG. 7 A block diagram showing the keyless entry system according to a third embodiment of the invention.

FIG. 8 A diagram illustrating the operation for adjusting the radiowave coverage area in the third embodiment.

FIG. 9 A block diagram showing an example of application to a TPMS.

FIG. 10 A block diagram showing an example of a modified configuration of a keyless entry system according to the invention.

### LIST OF REFERENCE SYMBOLS

1a-1c Transmitter/Receiver Units (Car-Mounted Units)
2 Power Supply Unit
10a, 10b Transmission Antenna Driver IC
11a, 11b Supply Voltage Input Portion
12 Triangular-Wave Generation Portion
13a, 13b Comparison Portion
14 Driving Logic Portion
15 Gate Driving Portion
16 Output Portion
30 Transmission Antenna Driver IC
31 Supply Voltage Input Portion
32 Analog/Digital Conversion Portion
33 Driving Logic Portion
34 Gate Driving Portion
35 Output Portion
20 Transmission Antenna Portion (RCL Series Resonance Circuit)
T1 Power Terminal
T2 Ground Terminal
T3 Clock Terminal
T4 Output Terminal
R1-R4 Resistors
AMP Amplifier
E Direct-Current Source
HN(1-n) N-Channel Field-Effect Transistors (Upper Power Transistors)
LN(1-n) N-Channel Field-Effect Transistors (Lower Power Transistors)
R Externally Fitted Resistor
C Externally Fitted Capacitor
L Externally Fitted Coil
A1-A6 Arrangement Locations
a1-a6 Radiowave Coverage Areas
100, 200 Automobiles
101a-101d TPMS Sensors
102, 201 ECU
103a-103d, 202a-202e Transmission Antenna Portions
104a-104d Tires
204 Smart Key

### BEST MODE FOR CARRYING OUT THE INVENTION

Hereinafter, the present invention will be described in detail by way of embodiments in which it is applied to, for example, a passive keyless entry system for a vehicle.

First, a keyless entry system according to a first embodiment of the invention will be described.

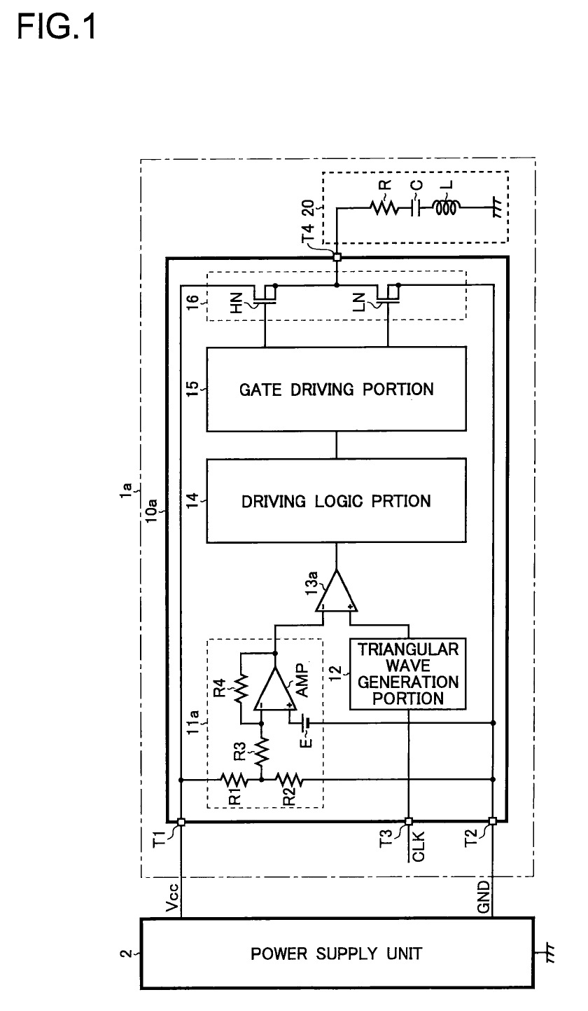

FIG. 1 is a block diagram showing the keyless entry system according to the first embodiment of the invention (in particular, around a transmission block in a transmitter/receiver unit provided on the part of a vehicle). As shown in this figure, the keyless entry system of this embodiment includes, on the part of the vehicle, a transmitter/receiver unit 1a and a power supply unit 2 that supplies electric power to it. The configuration here is such that a door lock mechanism (unillustrated) is locked/unlocked according to whether or not communication is established between the transmitter/receiver unit 1a and a remote-control key (unillustrated) carried around by a user.

The transmitter/receiver unit 1a includes a transmission antenna driver IC (integrated circuit) 10a and a transmission antenna portion 20, and further includes, among others, a reception block (unillustrated) for receiving a response signal from the remote-control key.

The transmission antenna driver IC 10a is a semiconductor integrated circuit device including a supply voltage input portion 11a, a triangular wave generation portion 12, a comparison portion 13a, a driving logic portion 14, a gate driving portion 15, and an output portion 16, and controls the output of the transmission antenna portion 20.

The supply voltage input portion 11a includes resistors R1 to R4, a direct-current voltage source E, and an amplifier AMP. One end of the resistor R1 is connected to a power terminal T1 to which a supply voltage Vcc from the power supply unit 2 is applied. The other end of the resistor R1 is connected to one end of the resistor R2 and to one end of the resistor R3. The other end of the resistor R2 is connected to a ground terminal T2 to which a ground voltage GND from the power supply unit 2 is applied. The other end of the resistor R3 is connected to the inverting input terminal (−) of the amplifier AMP. The non-inverting input terminal (+) of the amplifier AMP is connected to the positive terminal of the direct-current voltage source E. The negative terminal of the direct-current voltage source E is connected to the ground terminal T2. The output terminal of the amplifier AMP is connected to the inverting input terminal (−) of the comparison portion 13, and is also connected via the resistor R4 to the inverting input terminal (−) of the amplifier AMP itself. Configured as described above, the supply voltage input portion 11 inverts and amplifies the division voltage, appearing at the node between the resistors R1 and R2, of the supply voltage Vcc and feeds the resulting amplifier output signal (a monitoring voltage signal that varies with the supply voltage Vcc) to the inverting input terminal (−) of the comparison portion 13.

The triangular wave generation portion 12 charges and discharges a capacitor (unillustrated) with a clock pulse CLK having a predetermined frequency that is fed to a clock terminal T3, and thereby generates a triangular-wave signal having a prescribed waveform. The triangular wave generation portion 12 then feeds the triangular-wave signal to the non-inverting input terminal (+) of the comparison portion 13.

The comparison portion 13a compares the amplifier output signal fed from the supply voltage input portion 11a with the triangular-wave signal fed from the triangular wave generation portion 12, and feeds the result of the comparison to the driving logic portion 14. The output logic level of the comparison portion 13a is low when the potential of the amplifier output signal is higher than that of the triangular-wave signal, and is otherwise high.

Based on the comparison result signal fed from the comparison portion 13a, the driving logic portion 14 generates a rectangular-wave signal needed for the gate driving portion 15 to generate gate signals. The driving logic portion 14 receives, in addition to the comparison result signal, various IC protection signals (such as a high-voltage lockout signal, a low-voltage lockout signal, an overheat protection signal, and an overcurrent protection signal, of which none is illustrated) so as to control, according to those IC protection signals, whether or not to operate the gate driving portion 15 (whether or not to make it output the rectangular-wave signal).

The gate driving portion 15 operates by being fed with a stepped-up voltage. Based on the rectangular-wave signal fed from the driving logic portion 14, the gate driving portion 15 generates gate signals for the power transistors that constitute the output portion 16.

The output portion 16 includes an upper switch and a lower switch (N-channel field-effect transistors HN and LN) that are connected in series between two different potentials (between Vcc and GND), and an output current to the transmission antenna portion 20 is derived from the node between those transistors. The drain of the transistor HN is connected to the power terminal T1. The source of the transistor HN is connected to an output terminal T4. The gate of the transistor HN is connected to a gate signal output terminal (upper) of the gate driving portion 15. The backgate of the transistor HN is connected to its own source. The drain of the transistor LN is connected to the output terminal T4. The source of the transistor LN is connected to the ground terminal T2. The gate of the transistor LN is connected to a gate signal output terminal (lower) of the gate driving portion 15. The backgate of the transistor LN is connected to its own source. Configured as described above, the output portion 16 turns on and off the transistors HN and HL according to the gate signals from the gate driving portion 15 to thereby control the output of the transmission antenna portion 20 connected to the output terminal T4.

The transmission antenna portion 20 is an RLC series resonance circuit including an externally fitted resistor R, an externally fitted capacitor C, and an externally fitted coil L; the output terminal T4 of the transmission antenna driver IC 10a is thus grounded via the resistor R, the capacitor C, and the coil L. The transmission antenna portion 20 may be configured as any other type of oscillation circuit (e.g., an LC series resonance circuit) than an RLC series resonance circuit.

In the keyless entry system configured as described above, the transmitter/receiver unit 1a, on the one hand, transmits a request signal (start signal) targeted at the remote-control key at predetermined time intervals and, on the other hand, monitors for a response signal from the remote-control key so as to control locking/unlocking of the door lock mechanism according to whether or not two-way communication is established (whether or not the response signal is received).

For example, when the user comes close to the vehicle whose door lock mechanism is locked, the remote-control key carried around by the user receives the request signal from the transmitter/receiver unit 1a and in response transmits a response signal. When the transmitter/receiver unit 1a receives the response signal from the remote-control key, it recognizes that two-way communication with the remote-control key is established, and thus feeds the door lock mechanism with a command to unlock.

When the user remains away from the vehicle whose door lock mechanism is locked, no remote-control key is present nearby that receives the request signal. Thus, even through the transmitter/receiver unit 1a transmits a request signal, it never receives a response signal in response. When the transmitter/receiver unit 1a receives no response signal from the remote-control key in this way, it recognizes that no two-way communication with the remote-control key is established, and thus keeps the door lock mechanism locked.

When the user goes away from the vehicle whose door lock mechanism is unlocked, the remote-control key that has thus far been receiving the request signal ceases to present nearby, and thus the transmitter/receiver unit 1a ceases to receive the response signal. When the transmitter/receiver unit 1a ceases to receive a response signal from the remote-control key in this way, it recognizes that two-way communication with the remote-control key is no longer established, and thus feeds the door lock mechanism a command to lock.

That is, in the keyless entry system of this embodiment, when the user comes so close to the vehicle that two-way communication is established between the transmitter/receiver unit 1a and the remote-control key, the door lock mechanism is automatically unlocked; on the other hand, when the user goes so far away from the vehicle that no two-directional communication is established, the door lock mechanism is automatically locked.

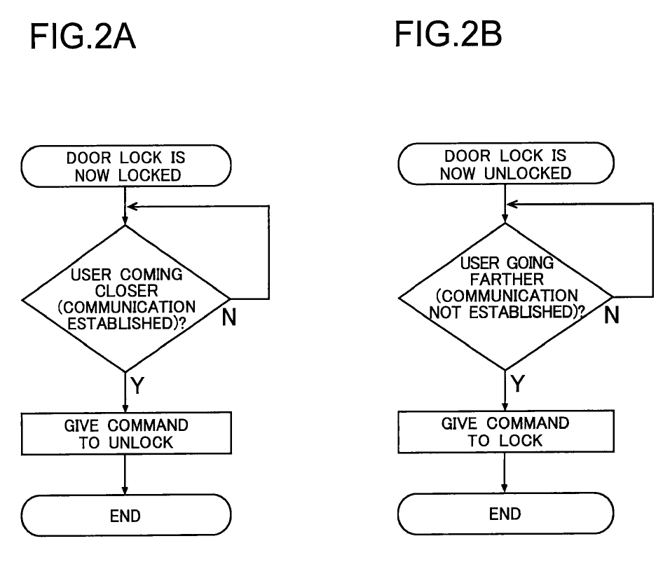

FIG. 2 shows flow charts of the door lock control operations described above FIG. 2(a) shows the control operation performed when the door lock mechanism is locked, and FIG. 2(a) shows the control operation performed when the door lock mechanism is unlocked.

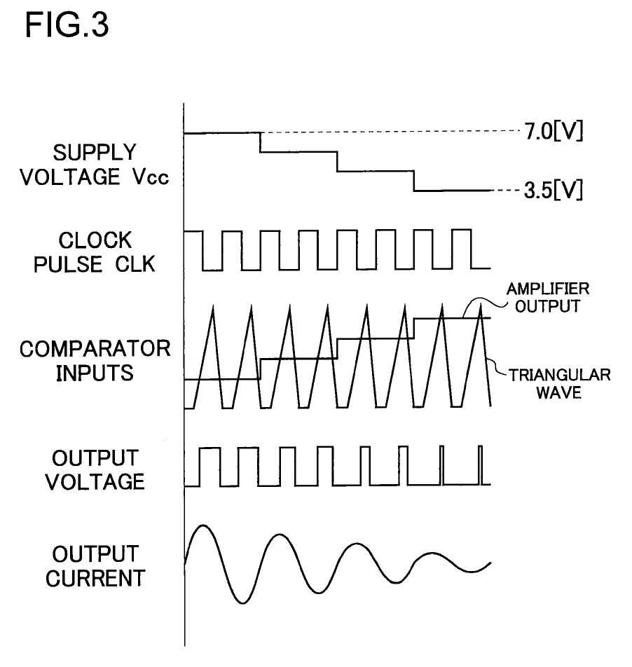

Next, a detailed description will be given of the operation for adjusting the radiowave coverage area in the keyless entry system of this embodiment. FIG. 3 is a diagram illustrating the operation for adjusting the radiowave coverage area, and shows, from above, the supply voltage Vcc, the clock pulse CLK, the input signals to the comparison portion 13a (the amplifier output signal and the triangular-wave signal), the output voltage appearing at the output terminal T4, and the output current flowing at the output terminal T4.

As shown in this figure, in the transmitter/receiver unit 1a of this embodiment, the higher the supply voltage Vcc, the lower the voltage level of the amplifier output signal fed to the inverting input terminal (−) of the comparison portion 13a and, the lower the supply voltage Vcc, the higher the voltage level of the amplifier output signal. By contrast, the triangular-wave signal fed to the non-inverting input terminal (+) of the comparison portion 13a has a constant wave form irrespective of the supply voltage Vcc.

Accordingly, the duty ratio (the proportion of the high-level output period in the total output period) of the comparison result signal outputted from the comparison portion 13a is higher (e.g., 50% at the maximum) the higher the supply voltage Vcc, and is lower the lower the supply voltage Vcc.

As described above, based on the comparison result signal fed from the comparison portion 13a, the driving logic portion 14 generates a rectangular-wave signal needed for the gate driving portion 15 to generate gate signals and, based on the rectangular-wave signal fed from the driving logic portion 14, the gate driving portion 15 generates gate signals for the power transistors HN and LN constituting the output portion 16. In view of this, the transmitter/receiver unit 1a of this embodiment can be said to be so configured as to include means (the supply voltage input portion 11a, the triangular wave generation portion 12, and the comparison portion 13a) for variably setting, according to the level of the supply voltage Vcc, the duty ratio at which the power transistors HN and LN are driven (and hence the duty ratio of the output voltage).

In the keyless entry system of this embodiment, the supply voltage Vcc is varied within a range within which the different parts of the transmitter/receiver unit 1a can operate normally, that is, within the range (e.g., 3.5 to 7 V) within which the transmitter/receiver unit 1 tolerates the supply voltage Vcc to vary. The supply voltage Vcc may be varied in any number of steps other than specifically shown in FIG. 3; the number of steps may be increased/decreased as required to suit the number of steps in which the radiowave coverage area of the transmission antenna portion 20 is desired to be varied. The supply voltage Vcc may even be varied continuously.

Configured as described above, the keyless entry system of this embodiment allows the duty ratio of the output voltage, and hence the level of the output current, to be adjusted as desired simply by appropriately setting the level of the supply voltage Vcc while keeping the resistance of the externally fitted resistor R constant. This makes it possible to adjust the radiowave coverage area of the transmission antenna portion 20 easily without replacing one externally fitted resistor R with another.

Moreover, as a result of the transmitter/receiver unit 1a of this embodiment being so configured as to adjust the duty ratio of the output voltage according to the supply voltage Vcc, it is not necessary to use an extra control signal to adjust the radiowave coverage area. This helps avoid unnecessarily increasing the number of external terminals provided in the transmission antenna driver IC 10a.

The voltage level of the amplifier output signal generated by the supply voltage input portion 11a and the signal waveform of the triangular-wave signal generated by the triangular wave generation portion 12 are previously so set that the desired duty ratio is obtained.

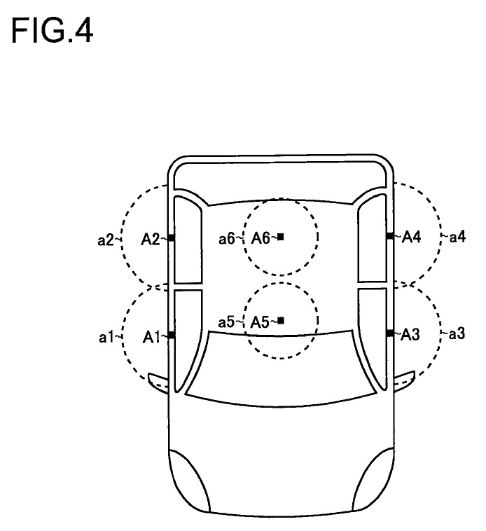

FIG. 4 is a diagram illustrating the radiowave coverage area in relation to the location where the transmitter/receiver unit is arranged. As shown in this figure, for transmitter/receiver units that are arranged at locations A1 to A4 outside the vehicle cabin, to alleviate establishment of two-way communication with a remote-control key present nearby, their radiowave coverage areas a1 to a4 need to be made comparatively large. On the other hand, for transmitter/receiver units that are arranged at locations A5 and A6 inside the vehicle cabin, to prevent leakage of the radiowaves and the like, their radiowave coverage areas a5 and a6 need to be limited within the cabin. With the keyless entry system of this embodiment, such requirements can be easily coped with because it allows the radiowave coverage areas of the individual transmission antenna portions to be adjusted appropriately to suit their arrangement locations simply by appropriately setting the level of the supply voltage Vcc.

More specifically, for the transmitter/receiver units arranged at locations A1 to A4, the supply voltage Vcc is set comparatively high to increase the duty ratio of the output voltage and to increase the output current through the transmission antenna portion so that the radiowave coverage areas a1 to a4 are comparatively large. On the other hand, for the transmitter/receiver units arranged at locations A5 to A6, the supply voltage Vcc is set comparatively low to decrease the duty ratio of the output voltage and to decrease the output current through the transmission antenna portion so that the radiowave coverage areas a5 and a6 are comparatively small.

Next, a keyless entry system according to a second embodiment of the invention will be described.

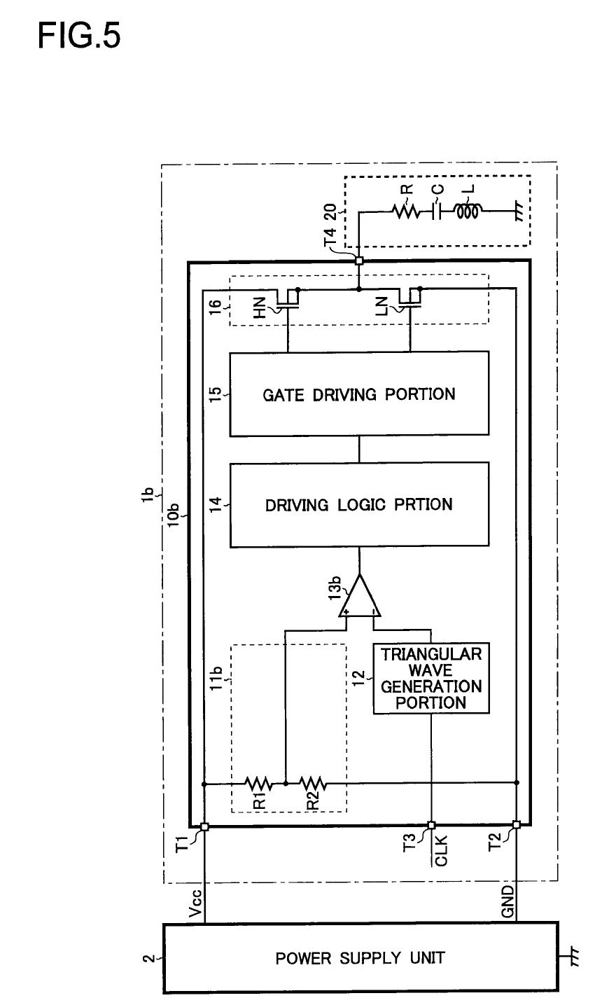

FIG. 5 is a block diagram showing the keyless entry system according to the second embodiment of the invention (in particular, around a transmission block in a transmitter/receiver unit provided on the part of a vehicle).

As shown in this figure, the keyless entry system of this embodiment has largely the same configuration as that of the first embodiment described previously. Accordingly, such components as find their counterparts in the first embodiment will be identified with the same reference numerals and symbols as those used in FIG. 1, and their description will not be repeated. Thus, the following description proceeds with emphasis placed on the features unique to this embodiment.

In the transmitter/receiver unit 1b of this embodiment, the supply voltage input portion 11b of the transmission antenna driver IC 10b is so configured as to directly feed the division voltage signal, appearing at the node between the resistors R1 and R2, of the supply voltage Vcc to the non-inverting input terminal (+) of the comparison portion 13b.

The comparison portion 13b compares the division voltage signal fed to its non-inverting input terminal (+) from the supply voltage input portion 11b with the triangular-wave signal fed to its inverting input terminal (−) from the triangular wave generation portion 12, and feeds the result of the comparison to the driving logic portion 14. The output logic level of the comparison portion 13b is high when the division voltage signal is higher than the triangular-wave signal, and is otherwise low.

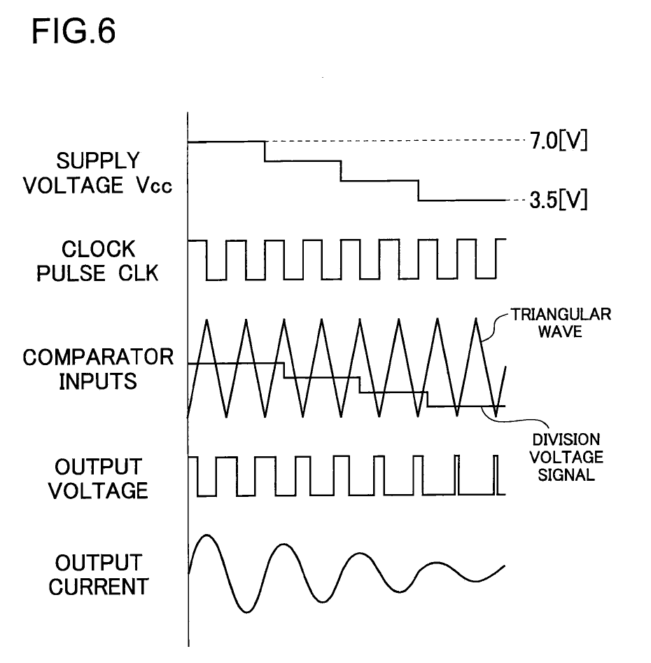

Next, a detailed description will be given of the operation for adjusting the radiowave coverage area in the keyless entry system of this embodiment. FIG. 6 is a diagram illustrating the operation for adjusting the radiowave coverage area, and shows, from above, the supply voltage Vcc, the clock pulse CLK, the input signals to the comparison portion 13b (the division voltage signal and the triangular-wave signal), the output voltage appearing at the output terminal T4, and the output current flowing at the output terminal T4.

As shown in this figure, in the transmitter/receiver unit 1b of this embodiment, the higher the supply voltage Vcc, the higher the voltage level of the division voltage signal fed to the inverting non-inverting input terminal (+) of the comparison portion 13b and, the lower the supply voltage Vcc, the lower the voltage level of the division voltage signal. By contrast, the triangular-wave signal fed to the inverting input terminal (−) of the comparison portion 13b has a constant wave form irrespective of the supply voltage Vcc.

Accordingly, the duty ratio (the proportion of the high-level output period in the total output period) of the comparison result signal outputted from the comparison portion 13b is higher (e.g., 50% at the maximum) the higher the supply voltage Vcc, and is lower the lower the supply voltage Vcc.

The voltage level of the division voltage signal generated by the supply voltage input portion 11b and the signal waveform of the triangular-wave signal generated by the triangular wave generation portion 12 are previously so set that the desired duty ratio is obtained.

Configured as described above, the keyless entry system of this embodiment, despite having a simpler configuration than that of the first embodiment but just like it, allows the duty ratio of the output voltage, and hence the level of the output current, to be adjusted as desired simply by appropriately setting the level of the supply voltage Vcc while keeping the resistance of the externally fitted resistor R constant. This makes it possible to adjust the radiowave coverage area of the transmission antenna portion 20 without replacement of one externally fitted resistor R with another.

Moreover, as a result of the transmitter/receiver unit 1b of this embodiment being so configured as to adjust the duty ratio of the output voltage according to the supply voltage Vcc, it is not necessary to use an extra control signal to adjust the radiowave coverage area. This helps avoid unnecessarily increasing the number of external terminals provided in the transmission antenna driver IC 10b.

Next, a keyless entry system according to a third embodiment of the invention will be described.

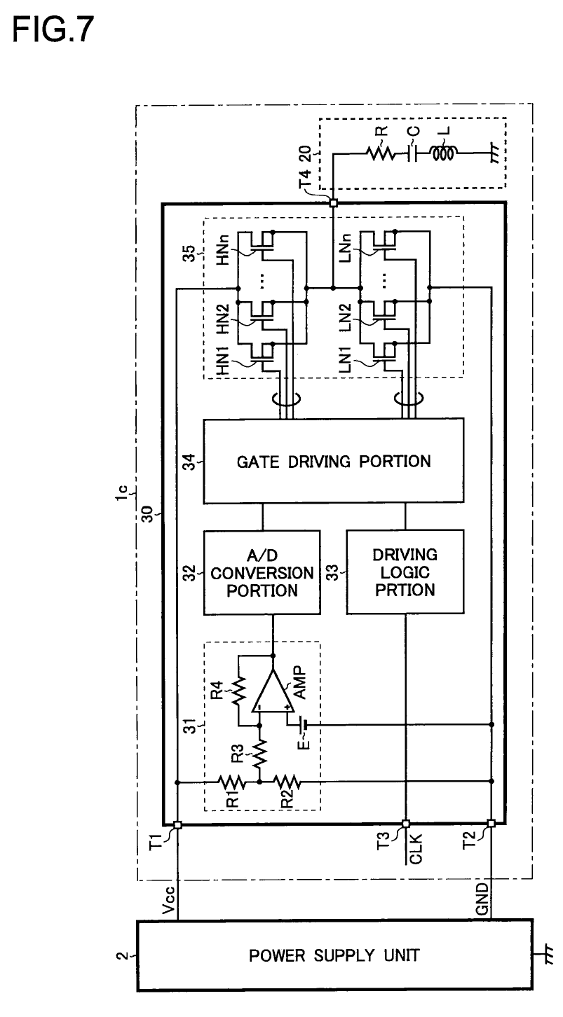

FIG. 7 is a block diagram showing the keyless entry system according to the third embodiment of the invention (in particular, around a transmission block in a transmitter/receiver unit provided on the part of a vehicle). As shown in this figure, the keyless entry system of this embodiment includes, on the part of the vehicle, a transmitter/receiver unit 1c and a power supply unit 2 that supplies electric power to it. The configuration here is such that a door lock mechanism (unillustrated) is locked/unlocked according to whether or not communication is established between the transmitter/receiver unit 1c and a remote-control key (unillustrated) carried around by a user.

The transmitter/receiver unit 1c includes a transmission antenna driver IC (integrated circuit) 30 and an antenna 20, and further includes, among others, a reception block (unillustrated) for receiving a response signal from the remote-control key.

The transmission antenna driver IC 30 includes a supply voltage input portion 31, an analog/digital conversion portion 32 (hereinafter “A/D conversion portion 32”), a driving logic portion 33, a gate driving portion 34, and an output portion 35, and controls the output of the transmission antenna portion 20.

The supply voltage input portion 31 includes resistors R1 to R4, a direct-current voltage source E, and an amplifier AMP. One end of the resistor R1 is connected to a power terminal T1 to which a supply voltage Vcc from the power supply unit 2 is applied. The other end of the resistor R1 is connected to one end of the resistor R2 and to one end of the resistor R3. The other end of the resistor R2 is connected to a ground terminal T2 to which a ground voltage GND from the power supply unit 2 is applied. The other end of the resistor R3 is connected to the inverting input terminal (−) of the amplifier AMP. The non-inverting input terminal (+) of the amplifier AMP is connected to the positive terminal of the direct-current voltage source E. The negative terminal of the direct-current voltage source E is connected to the ground terminal T2. The output terminal of the amplifier AMP is connected to the input terminal of the A/D conversion portion 32, and is also connected via the resistor R4 to the inverting input terminal (−) of the amplifier AMP itself. Configured as described above, the supply voltage input portion 31 inverts and amplifies the division voltage, appearing at the node between the resistors R1 and R2, of the supply voltage Vcc, and then feeds the resulting voltage to the A/D conversion portion 32.

The A/D conversion portion 32 converts the analog voltage (amplifier output voltage) fed from the supply voltage input portion 31 into a digital signal, and feeds the resulting signal to the gate driving portion 34.

Based on a clock pulse CLK having a predetermined frequency that is fed to a clock terminal T3, the driving logic portion 33 generates a rectangular-wave signal needed for the gate driving portion 34 to generate gate signals. The driving logic portion 33 receives, in addition to the clock pulse CLK, various IC protection signals (such as a high-voltage lockout signal, a low-voltage lockout signal, an overheat protection signal, and an overcurrent protection signal, of which none is illustrated) so as to control, according to those IC protection signals, whether or not to operate the gate driving portion 34 (whether or not to make it output the rectangular-wave signal).

The gate driving portion 34 operates by being fed with a stepped-up voltage. Based on the rectangular-wave signal (a first control signal) fed from the driving logic portion 33, the gate driving portion 34 generates gate signals for the power transistors that constitute the output portion 35. Moreover, in this embodiment, the gate driving portion 34 also has a transistor selection function whereby it, based on the digital signal (i.e., a second control signal corresponding to the level of the supply voltage Vcc) fed from the A/D conversion portion 32, appropriately selects which power transistors to drive (i.e., a function for controlling how many of the gates of the power transistors to drive). This transistor selection function will be described in detail later.

In the output portion 35, the output current to the transmission antenna portion 20 is derived from the node between an upper switch and a lower switch that are connected in series between two different potentials (Vcc and GND). The upper and lower switches are each configured as a switch element group composed of a plurality of switch elements connected in parallel with one another. Specifically, the output portion 35 includes, as the switch elements constituting the upper switch, a plurality of N-channel field-effect transistors (upper power transistors) HN1 to HNn and, as the switch elements constituting the lower switch, a plurality of N-channel field-effect transistors (lower power transistors) LN1 to LNn. The drains of the transistors HN1 to HNn are all connected to the power terminal T1. The sources of the transistors HN1 to HNn are all connected to the output terminal T4. The gates of the transistors HN1 to HNn are each connected to a gate signal output terminal (upper) of the gate driving portion 34. The backgates of the HN1 to HNn are connected to their own sources respectively. The drains of the transistors LN1 to LNn are all connected to the output terminal T4. The sources of the transistors LN1 to LNn are all connected to the ground terminal T2. The gates of the transistors LN1 to LNn are each connected to a gate signal output terminal (lower) of the gate driving portion 34. The backgates of the LN1 to LNn are connected to their own sources respectively. Configured as described above, the output portion 35 turns on and off the transistors HN1 to HNn and LN1 to LNn according to the gate signals fed from the gate driving portion 34, and thereby controls the output of the transmission antenna portion 20 connected to the output terminal T4.

The transmission antenna portion 20 is an RLC series resonance circuit including an externally fitted resistor R, an externally fitted capacitor C, and an externally fitted coil L; the output terminal T4 of the transmission antenna driver IC 30 is thus grounded via the resistor R, the capacitor C, and the coil L. The transmission antenna portion 20 may be configured as any other type of oscillation circuit (e.g., an LC series resonance circuit) than an RLC series resonance circuit.

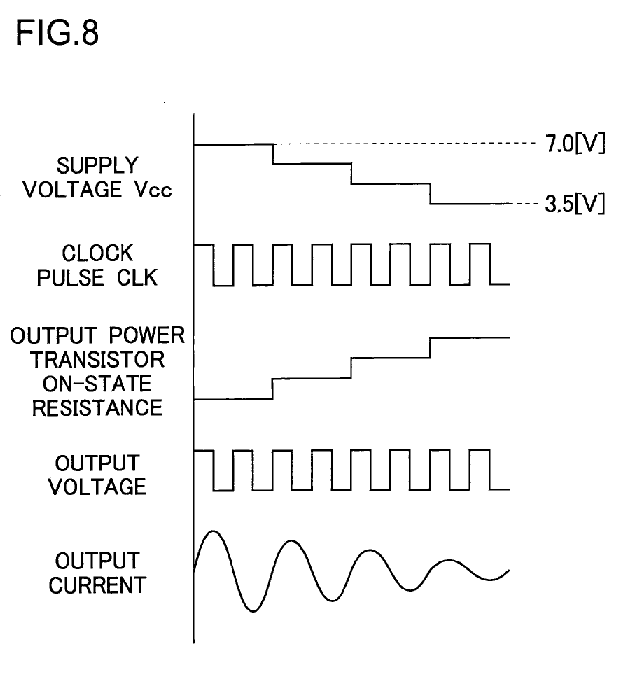

Next, a detailed description will be given of the operation for adjusting the radiowave coverage area in the keyless entry system of this embodiment. FIG. 8 is a diagram illustrating the operation for adjusting the radiowave coverage area, and shows, from above, the supply voltage Vcc, the clock pulse CLK, the on-state resistances of the power transistors constituting the output portion 35, the output voltage appearing at the output terminal T4, and the output current flowing at the output terminal T4.

As described previously, in the transmitter/receiver unit 1c of this embodiment, the gate driving portion 34 has the function whereby it, based on the digital signal fed from the A/D conversion portion 32 (i.e., according to the level of the supply voltage Vcc), appropriately selects which power transistors to drive.

Specifically, in the example shown in the figure, the higher the supply voltage Vcc, the gate driving portion 34 drives a larger number of gates in each of the upper and lower power transistor groups HN1 to HNn and LN1 to LNn; that is, the lower the supply voltage Vcc, the gate driving portion 34 drives a smaller number of gates. In other words, if the upper and lower power transistor groups are each regarded as a single power transistor, then the gate driving portion 34 so operates as to decrease the on-state resistance of the power transistor the higher the supply voltage Vcc and increase the on-state resistance of the power transistor the lower the supply voltage Vcc.

In the keyless entry system of this embodiment, the supply voltage Vcc is varied within a range within which the different parts of the transmitter/receiver unit 1c can operate normally, that is, within the range (e.g., 3.5 to 7 V) within which the transmitter/receiver unit 1 tolerates the supply voltage Vcc to vary. The supply voltage Vcc may be varied in any number of steps other than specifically shown in FIG. 8; the number of steps may be increased/decreased as required to suit the number of steps in which the radiowave coverage area of the transmission antenna portion 20 is desired to be varied. The supply voltage Vcc may even be varied continuously.

Configured as described above, the keyless entry system of this embodiment allows the on-state resistances of the power transistors, and hence the level of the output current, to be adjusted as desired simply by appropriately setting the level of the supply voltage Vcc while keeping the resistance of the externally fitted resistor R constant. This makes it possible to adjust the radiowave coverage area of the transmission antenna portion 20 easily without replacing one externally fitted resistor R with another.

Moreover, as a result of the transmitter/receiver unit 1c of this embodiment being so configured as to increase or decrease the number of gates driven in the output portion 35 according to the supply voltage Vcc, it is not necessary to use an extra control signal to adjust the radiowave coverage area. This helps avoid unnecessarily increasing the number of external terminals provided in the transmission antenna driver IC 10.

The on-state resistances of the power transistors HN1 to HNn and LN1 to LNn constituting the output portion 35 may be equal, or may vary from one another. It is, however, necessary that the devise sizes of the individual power transistors be so set that the maximum output current obtained when the maximum number of gates of the power transistors are driven reaches the desired level. The number of power transistors HN1 to HNn and LN1 to LNn used is appropriately set to suit the number of steps in which the radiowave coverage area of the transmission antenna portion 20 is desired to be varied.

It is preferable to give the A/D conversion portion 32 as high a resolution (quantization bit number) as practical because increasing its performance helps improve the accuracy with which the level of the output current (and hence the radiowave coverage area of the transmission antenna portion 20) can be controlled.

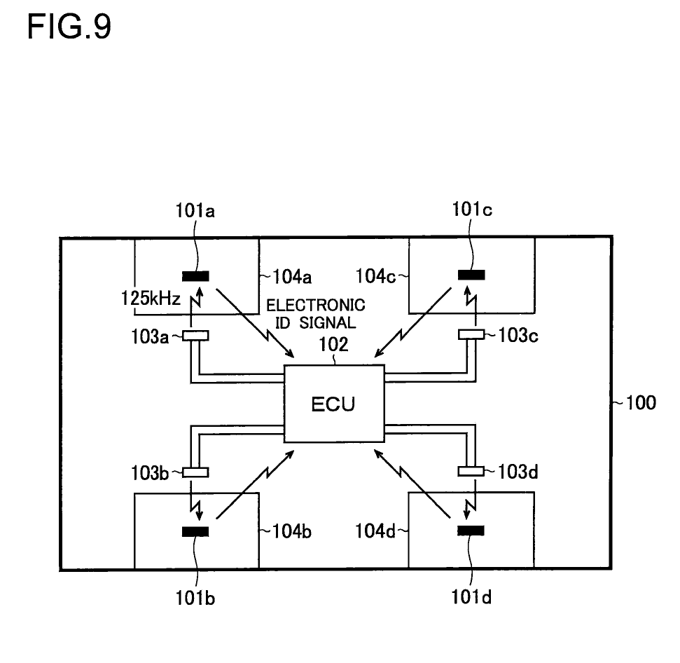

Although the embodiments described above deal with cases where the present invention is applied to a passive keyless entry system for a vehicle, this is not meant to limit in any way the application of the invention; for example, as shown in FIG. 9, the invention can also be suitably applied to a TPMS mounted on an automobile 100 to serve as means (including an ECU (electronic control unit) 102 and transmission antenna portions 103a to 103d) for transmitting a request signal to TPMS sensors 101a to 101d.

The TPMS mentioned above is a system that monitors the pneumatic pressures and temperatures of tires 104a to 104d individually with compact TPMS sensors 101a to 101d fitted inside the tire valves (unillustrated) of an automobile 100 for the purpose of, in case of an abnormality such as an abnormally low pneumatic pressure or abnormally high temperature, transmitting an electronic ID signal (a signal by which an abnormal tire is identified) from transmitters (unillustrated) incorporated in the TPMS sensors 101a to 101d to the ECU 102 in order to light a warning lamp (unillustrated) on the instrument panel and thereby give a warning. Here, the request signal is transmitted at a frequency of, for example, 125 kHz, from the transmission antenna portions 103a to 103d to the TPMS sensors 101a to 101d.

Thus, the invention finds wide application in transmission devices in general that transmit a signal by use of an antenna within a comparatively limited radiowave coverage area (e.g., transmission devices used in IC card ticket inspection systems).

The invention may also be applied to vehicle systems provided with a plurality of suspension units whose operation is controlled based on wireless communication with a vehicle body unit (e.g., vehicle floor level adjustment systems for buses that tilt the body of a bus toward a sidewalk when passengers get on and off it, and active suspension systems that control the suspensions of four wheels independently according to the surface condition of roads), in which case the invention serves as a transmission device in the vehicle body unit. Applied in this way, the invention allows such systems to be built easily not only during but even after the assembly of a vehicle.

The invention may be practiced in any manner other than specifically described by way of embodiments above, and many modifications and variations are possible within the spirit of the invention.

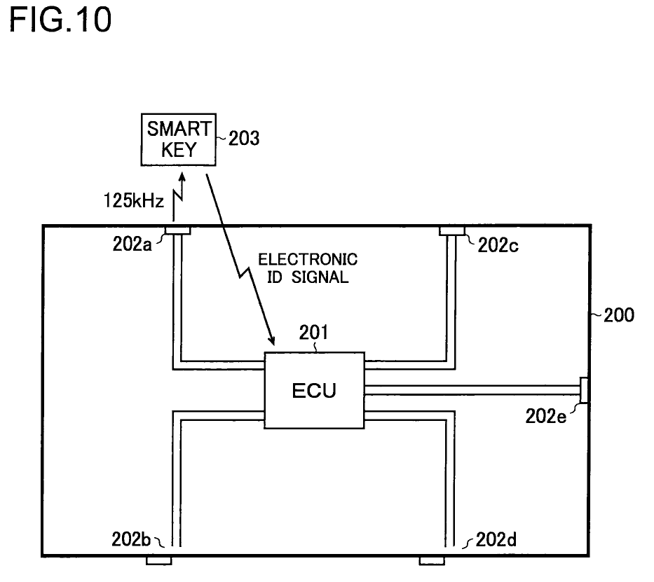

For example, although the embodiments described above deal with cases where the invention is applied to the transmitter/receiver unit in a keyless entry system, taking up as an example a configuration in which such transmitter/receiver units are arranged at different locations in an automobile. this is not meant to limit in any way the configuration with which the invention is practiced. For example, it is also possible to adopt a configuration as shown in FIG. 10 in which a transmitter/receiver unit according to the invention is arranged in a centralized fashion in an ECU 201 and, at different locations in an automobile 200, only transmission antenna portions 202a to 202e for transmitting a request signal to a smart key 203 are arranged. Here, the request signal is transmitted at a frequency of, for example, 125 kHz from the transmission antenna portions 202a to 202e individually.

Although the description given with reference to FIGS. 1, 5, and 7 above deals with examples in which N-channel field-effect transistors are used as all the upper and lower switch elements in the output portion, this is not meant to limit in any way the configuration with which the invention is practiced. It is also possible to use P-channel field-effect transistors as the upper switch elements.

### INDUSTRIAL APPLICABILITY

The present invention is suitably applied to, for example, passive keyless entry systems for vehicles that allow non-contact, automatic locking and unlocking of a door lock mechanism and TPMSs that monitor the pneumatic pressure and temperature of tires to warn about an abnormality such as an abnormally low pneumatic pressure or abnormally high temperature.

What is claimed is:

1. A transmission device comprising:
a transmission antenna portion;
an output portion having a first switch and a second switch connected in series between two different potentials, an output current fed to the transmission antenna portion being derived from a node between the first and second switches;
an output driving portion controlling turning-on and -off of the first and second switches; and
duty ratio setting means for variably setting a duty ratio at which the output driving portion drives the first and second switches.

2. The transmission device of claim 1,
wherein the duty ratio setting means comprises
a supply voltage input portion generating a monitoring voltage signal varying with a supply voltage supplied to the device;
a triangular wave generator generating a triangular-wave signal having a constant waveform; and
a comparison portion comparing the monitoring voltage signal with the triangular-wave signal, and
wherein, based on a comparison result signal obtained from the comparator portion, the output driving portion generates control signals by which the turning-on and -off of the first and second switches are controlled.

3. A keyless entry system comprising:
a remote-control key;
a transmitter/receiver unit performing two-way communication with the remote-control key;
a power supply unit supplying electric power to the transmitter/receiver unit; and
a lock mechanism locked and unlocked according to whether or not two-way communication is established between the transmitter/receiver unit and the remote-control key,
wherein the transmitter/receiver unit comprises the transmission device of claim 1 as signal transmitting means.

4. A tire pneumatic pressure monitoring system comprising:
a sensor for monitoring pneumatic pressure or temperature of a tire;
a transmitter/receiver unit performing two-way communication with the sensor; and
a power supply unit supplying electric power to the transmitter/receiver unit,
wherein the transmitter/receiver unit comprises the transmission device of claim 1 as signal transmitting means.

5. A transmission device comprising:
a transmission antenna portion;
an output portion having a first switch and a second switch connected in series between two different potentials, an output current fed to the transmission antenna portion being derived from a node between the first and second switches; and
an output driving portion controlling turning-on and -off of the first and second switches according to a first control signal;
wherein the first and second switches are each a switch element group composed of a plurality of switch elements connected in parallel with one another, and, according to a second control signal, the output driving portion selects, from the plurality of switch elements, switch elements whose turning-on and -off is controlled according to the first control signal.

6. The transmission device of claim 5, wherein the output driving portion adjusts the output current by selecting among the switching elements.

7. The transmission device of claim 5, wherein the output current is adjusted by exploiting on-state resistances of the switching elements.

8. The transmission device of claim 5, further comprising:
means for generating the second control signal according to a supply voltage supplied to the device.

9. A keyless entry system comprising:
a remote-control key;
a transmitter/receiver unit performing two-way communication with the remote-control key;
a power supply unit supplying electric power to the transmitter/receiver unit; and
a lock mechanism locked and unlocked according to whether or not two-way communication is established between the transmitter/receiver unit and the remote-control key,
wherein the transmitter/receiver unit comprises the transmission device of claim 5 as signal transmitting means.

10. A tire pneumatic pressure monitoring system comprising:
a sensor for monitoring pneumatic pressure or temperature of a tire;
a transmitter/receiver unit performing two-way communication with the sensor; and
a power supply unit supplying electric power to the transmitter/receiver unit,
wherein the transmitter/receiver unit comprises the transmission device of claim 5 as signal transmitting means.
